(19) United States
(12) Patent Application Publication
(10) Pub. No.: US 2004/0175488 A1
(43) Pub. Date: Sep. 9, 2004

(54) Chewable caramel composition

(76) Inventor: Anthony J. Pellicone, Neptune, NJ (US)

Correspondence Address: ROBERT M. SKOLNIK, 353 Monmouth Road, PO Box 22, West Long Branch, NJ, 07764-0022, US

(21) Appl. No.: 10/379,166

(22) Filed: Mar. 4, 2003

(51) Int. Cl. A23G 3/00

(52) U.S. Cl. 426/660

(57) ABSTRACT

A chewable caramel composition consisting of approximately 25% flour; 45% sugar, 25% butter, 2.5% corn syrup and 2.5% milk maintains its chewable texture whether it is placed in the freezer, the refrigerator or left at room temperature.

### CROSS REFERENCE TO RELATED APPLICATIONS

None.

### BACKGROUND OF THE INVENTION

1. Field of the Invention

The present invention is a caramel composition, which maintains a chewy or crumbly texture regardless of whether it is placed in the freezer, the refrigerator, or stored at room temperature.

2. Description of the Related Art

Speed, U.S. Pat. No. 2,019,365 discloses a caramel mixture of sugars to improve the utility of the caramel alone by changing its texture.

### SUMMARY OF THE INVENTION

This invention relates to a composition for caramel, which has a chewable or crumbly texture. The composition produces a caramel that is immediately edible even when taken out of the freezer. The caramel remains chewable or crumbly when placed in the freezer, or the refrigerator, or maintained at room temperature. One embodiment of the composition consists of a béchamel sauce made from, in one example, ¼ cup of flour mixed with ½ stick unsalted butter (melted) and slightly cooked; one cup heavy cream (mixed constantly); one cup LACTAID® milk; mixed constantly and lightly boiled for a few minutes; the sauce is then refrigerated; after one day, mix 1 cup of the sauce with ⅛-cup water, ¼ cup corn syrup; one-cup sugar, and boil to a temperature not to exceed 215° F. until mixture starts to pull away from the sides of the pot. Remove from heat and add 1 tsp. vanilla; Wisk hard for about 20 seconds then put into a buttered pan or into aluminum foil. Let cool about 3 hours at room temperature.

More generally, I have found that the addition of about 25% by volume flour to a mixture including about 45% sugar, 25% butter, 2½% corn syrup and 2½% milk produces the desired chewy texture regardless of the temperature of the product.

A principal object of the invention is to provide a chewable caramel composition.

A further object is the provision of a caramel composition, which maintains its bitable texture at all useable temperatures (i.e. freezer, refrigerator or room temperatures).

Another object of the invention is the provision method of preparing a chewable caramel.

The foregoing, as well as further objects and advantages of the invention will become apparent to those skilled in the art from a review of the following detailed description of my invention.

### DETAILED DESCRIPTION OF THE PREFERRED EMBODIMENT

### Example 1

A chewable caramel was prepared based on a béchamel sauce made from, between ⅛—1 cup of flour mixed with ½ stick unsalted butter (melted) and slightly cooked; one cup heavy cream (mixed constantly); one cup LACTAID® milk or 2 cups of other milk; mixed constantly and lightly boiled for a few minutes. The sauce was then refrigerated and, after one day, mixed with 1 cup of the sauce with ⅛-cup water, ¼ cup corn syrup; one-cup sugar, and boiled (to 213° F.-215° F. until the mixture starts to pull away from the sides of the pot. Then, the pot was removed from heat and there was added 1 tsp. vanilla. The mixture is then mixed hard or aerated for about 20 seconds then put into a buttered pan or into aluminum foil. Let cool about 3 hours at room temperature.

### Example 2

The béchamel sauce was prepared in the same manner as in EXAMPLE 1 but was not refrigerated. The béchamel sauce was immediately used “hot”. Also, no water was utilized.

### Example 3

Another béchamel sauce was prepared by melting ½ stick butter with ½-cup flour, 1-cup heavy cream and 1-cup skim milk. The sauce was refrigerated for 1 day. Then, ½ cup of the sauce was mixed with 1-cup granular sugar, ¼ cup water; ¼ cup corn syrup and a flavoring, stirred and heated until it reached approximately 238°. The mixture was then removed from the heat and stirred vigorously for about 20 seconds. The heated mixture was then poured onto a pan where it can be shaped while hot. The resultant product is characterized by a hard crumbly texture.

### Example 4

The process of example 3 was repeated but without refrigeration of the béchamel sauce. It was used “hot”. In addition, no water was used.

### Example 5

More generally, I have found that the addition of about 25% flour to a mixture including about 45% sugar, 25% butter, 2.5% corn syrup and 2.5% milk produces the desired softening and chewy texture regardless of the temperature of the product. The flour is believed to inhibit the caramelized sugar from hardening to a brittle texture.

Further modifications to the apparatus of the invention may be made without departing from the spirit and scope of the invention; accordingly, what is sought to be protected is set forth in the appended claims.

What is claimed is:

1. A caramel composition composed of approximately 25% flour; 45% sugar, 25% butter, 2.5% corn syrup and 2.5% milk.

2. The method of making chewable caramel comprising the steps of preparing a béchamel sauce by mixing between ⅛—1 cup flour mixed with ½ stick unsalted butter (melted); slightly cooking the mixture; adding one cup heavy cream while mixing constantly; adding one cup LACTAID® milk or 2 cups of other milk; mixing the resultant mixture ed constantly and lightly boiling the mixture; then, adding ¼ cup corn syrup; one-cup sugar, and boiling the mixture to between 213° F.-215° F. until the mixture starts to pull away from the sides of the pot; removing the pot from heat and adding 1 tsp. vanilla; mixing the mixture hard or aerating it for about 20 seconds; then placing the mixture into a buttered pan or onto aluminum foil and cooling the mixture for about 3 hours at room temperature.

3. The method of making chewable caramel of claim 2 further including the steps of refrigerating said béchamel sauce for one day; then, mixing 1 cup of the sauce with ⅛-cup water before adding said ¼ cup corn syrup; one-cup sugar, and boiling the mixture to between 213° F.-215° F.

4. A method of making a chewable caramel comprising the steps of: preparing a béchamel sauce by melting ½ stick butter with ½-cup flour, 1-cup heavy cream and 1-cup skim milk; then, mixing ½ cup of the sauce with 1-cup granular sugar, ¼ cup corn syrup and a flavoring; stirring and heating the mixture until 238° F.; then removing the mixture from the heat and stirring it vigorously for about 20 seconds; and pouring the mixture onto a pan.

5. The method of claim 4 further including the steps of refrigerating the béchamel sauce for one day; and mixing ⅛ cup water into the béchamel sauce.
